(19) United States
(12) Patent Application Publication
(10) Pub. No.: US 2024/0138496 A1
(43) Pub. Date: May 2, 2024

(54) Inductively powered motorcycle accessories

(71) Applicant: Damon Motors Inc., Vancouver (CA)

(72) Inventors: Dominique Kwong, Coquitlam (CA); Jungwoong Yoon, Burnaby (CA); Elaine Morrison, Vancouver (CA)

(21) Appl. No.: 17/978,046

(22) Filed: Oct. 31, 2022

(51) Int. Cl. A41D 13/005; B62J 33/00; H02J 7/00; H02J 50/10; H02J 50/70; H05B 3/34

(52) U.S. Cl. CPC A41D 13/0051; B62J 33/00; H02J 7/00032; H02J 50/10; H02J 50/70; H05B 3/342

(57) ABSTRACT

Motorcycle riders may be exposed to cold weather. Herein, an electrical heating system in a garment is inductively powered from the motorcycle. Primary induction coils may be in the handlebar grips, tank area or other areas of the motorcycle. Garments may have a battery that is recharged inductively and powers heating elements in the garment. Rider accessories may also be wirelessly powered or charged. Rider comfort and convenience may contribute to improved rider response and safety.

### TECHNICAL FIELD

This invention relates to a system for improving rider comfort and safety on a motorcycle. More specifically, it relates to an inductive heating and charging system for accessories.

### BACKGROUND

Motorcycles by nature are an inherently dangerous mode of transportation, due to the direct exposure of riders to the environment and their vulnerability to surrounding traffic. Traditionally, motorcycle riders have had limited options when it comes to safety and convenience gear due to the motorcycle's physical profile and limited electrical energy storage capacity. Riders require appropriate equipment for diverse patterns of weather and basic physical needs, which are conveniently met in automobiles. Physical discomfort creates fatigue, and fatigued riders are prone to accidents.

Riders are also challenged with cumbersome accessory management on the roll in traffic. Awkward wired device operation is a distraction while navigating the road, and every contributing factor dividing concentration brings the rider a step closer to deteriorating awareness and errors in judgment and action.

US patent application publication 2008/0197126 to Bourke et al. discloses inductively heated clothing.

This background is not intended, nor should be construed, to constitute prior art against the present invention.

### SUMMARY OF THE INVENTION

The present invention relates to an inductive charging and heating system for improving rider comfort and safety on a motorcycle. The invention has elements in the power system which facilitate its use in a novel way. The inventors have realized with the ever-growing EV market, including electric motorcycles, that technological advancement allows electric motorcycles to support extra safety devices and gear for the riders.

The essence of the system is to utilize the available electrical energy to inductively power essential and/or convenient rider accessories, wirelessly, providing car-type benefits with the safety of untethered accessories beneficial on a motorcycle. By implementing an inductive capability on the electric motorcycle, it expands the rider's choices for accessory options. Both charging and heating processes can be carried out across the inductive interface.

Where included, the rider's gloves are inductively heated by the handlebar, warming the rider's palms and fingers, to reduce the rider's exposure to harsh environments such as cold temperatures and wind. The gloves may also be inductively charged for continued heating between rides. Via the tank area, inductive charging of the rider's jacket, if included, heats it and may power accessories stored in the pockets, and may carry current up to the collar and optional smart helmet. From the charge, the jacket may also be heated to warm the rider's torso.

The system avoids accessory management distractions while navigating. The rider is offered a higher degree of wireless freedom and simple electronic convenience using, for example, a smart helmet with a Bluetooth™ headset, camera, and RFID (radio-frequency identification) device identification and communication with individual peripherals.

The system potentially averts the fatigue and possible subsequent accidents originating in physical discomfort. When riders are equipped with extra safety gear and improved riding conditions, they tend to exhibit improved rider behavior with an enhanced ability to think quickly and perform agile maneuvers with faster response times, reducing the risk of an accident and making the road safer for everyone.

Disclosed is a motorcycle comprising: an induction zone; an electric circuit producing an alternating current; and a primary induction coil through which the alternating current flows, the primary induction coil located in the induction zone; wherein the primary induction coil is oriented to generate an alternating magnetic field outside an outer surface of the induction zone when the alternating current flows through the primary induction coil.

Disclosed is a system for wirelessly transferring electromagnetic energy comprising a motorcycle, comprising: an induction zone; an electric circuit producing an alternating current; and a primary induction coil through which the alternating current flows, the primary induction coil located in the induction zone; wherein the primary induction coil is oriented to generate an alternating magnetic field outside an outer surface of the induction zone when the alternating current flows through the primary induction coil; and a garment, comprising: a heating element; and an electrical conductor in the heating element or connected to transfer power to the heating element; wherein the electrical conductor is located so that it is in the alternating magnetic field when a wearer of the garment rides the motorcycle; wherein the alternating magnetic field induces further alternating current in the electrical conductor and the further alternating current is used to heat the heating element.

Disclosed is a method for wirelessly transferring electromagnetic energy comprising: producing an alternating current with an electric circuit in a motorcycle; flowing the alternating current through a primary induction coil that is located in an induction zone of the motorcycle; generating an alternating magnetic field outside an outer surface of the induction zone when the alternating current flows through the primary induction coil; inducing a further alternating current in an electrical conductor that is present in a garment that is worn by a rider of the motorcycle and located so that the electrical conductor is in the alternating magnetic field; and using the further alternating current to heat the garment via a heating element that comprises the electrical conductor or is connected to receive power from the electrical conductor.

Disclosed is a garment for wirelessly receiving electromagnetic energy comprising: a heating element; and an electrical conductor in the heating element or connected to transfer power to the heating element; wherein the electrical conductor is located so that, when a wearer of the garment rides a motorcycle, the electrical conductor is in an alternating magnetic field generated by the motorcycle; wherein the alternating magnetic field induces alternating current in the electrical conductor and the alternating current is used to heat the heating element.

This summary provides a simplified, non-exhaustive introduction to some aspects of the invention, without delineating the scope of the invention.

### BRIEF DESCRIPTION OF THE DRAWINGS

The following drawings illustrate embodiments of the invention, which should not be construed as restricting the scope of the invention in any way.

FIG. 1 is a schematic drawing of a motorcycle, according to an embodiment of the present invention.

FIG. 2 is a schematic drawing of an inductive handlebar grip, according to an embodiment of the present invention.

FIG. 3 is a schematic drawing of another inductive handlebar grip, according to an embodiment of the present invention.

FIG. 4 is a schematic drawing of an inductive glove, according to an embodiment of the present invention.

FIG. 5 is a schematic drawing of inductive heating, according to an embodiment of the present invention.

FIG. 6 is a schematic drawing of inductive charging, according to an embodiment of the present invention.

FIG. 7 is a schematic drawing of inductive heating, according to an embodiment of the present invention.

FIG. 8 is a schematic drawing of inductive charging, according to an embodiment of the present invention.

FIG. 9 is a schematic drawing of an inductive jacket, according to an embodiment of the present invention.

FIG. 10 is a schematic drawing of the front of another inductive jacket, according to an embodiment of the present invention.

FIG. 11 is a schematic drawing of the back of the other inductive jacket, according to an embodiment of the present invention.

FIG. 12 is a front view of a jacket shell, according to an embodiment of the present invention.

FIG. 13 is a block diagram of an inductive energy transfer system, according to the embodiment of the present invention.

### DETAILED DESCRIPTION

### A. Glossary

AC—Alternating current, which reverses direction periodically.

Conductor—an object or type of material that allows the flow of electric charge in one or more directions. Materials made of metal are common electrical conductors. Herein, conduction refers to electrical conduction, unless specifically qualified as thermal conduction.

DC—direct current, which maintains the same direction.

Eddy currents—loops of currents within the skin depth of portions of larger conductors that occur as a consequence of a changing magnetic field.

EMR—electromagnetic radiation. There is an induced EMR associated with the induced current, which opposes the change in magnetic flux created by AC electricity.

The term “firmware” includes, but is not limited to, program code and data used to control and manage the interactions between the various modules of the system, or to perform some or all of the control of the current generation, heating and charging.

GPS—global positioning system.

The term “hardware” includes, but is not limited to, the physical housing for a computer or controller, components of a circuit, controller or other components of a motorcycle, or components of a garment.

Induction—the process of generating current in a conductor by placing it in a changing magnetic field.

Induction zone—a volume within a motorcycle or other vehicle that is bounded in part by a surface that is part of an outer surface of the motorcycle or the other vehicle. Within the volume there is a primary induction coil for generating an alternating magnetic field outside the surface bounding the induction zone and that forms part of the outer surface of the motorcycle or other vehicle.

Magnetic flux—a measurement of the total magnetic field based on the number of magnetic field lines passing through a given closed surface area.

The term “module” can refer to any component in embodiments of this invention and to any or all of the features of embodiments of the invention without limitation. A module may be a software, firmware or hardware module, and may be located in the tank area, handlebar grips or elsewhere in the motorcycle, or in a garment.

PCB—printed circuit board. A PCB consists of conductive and non-conductive layers that are bonded together, with electric or electronic components mounted on the board and an electric of electronic circuit defined in the conductive layer.

The term “processor” or “microcontroller” or “microprocessor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs, for example, one or more of the control functions of embodiments of the invention. If the processor comprises multiple processors, they may be located together or separate from each other.

Rectifier—an electrical device which converts AC to DC.

Resonant coupling—inductive coupling becomes stronger when the target circuit of the loosely coupled coil resonates. Loosely coupled resonance works within a 5 cm distance, for example.

RF—radio frequency.

RFID—radio frequency identification, used in an RFID tag, for example.

SAR—specific absorption rate. A measure of the rate that RF energy is absorbed by the body per unit mass.

The term “software” includes, but is not limited to, program code that performs the computations necessary for determining, for example, the presence of an inductive garment in the vicinity of a motorcycle, the presence of its receptor coil or conductor in the alternating magnetic field produced by a motorcycle, and for controlling the induction process, garment heating or garment charging.

The term “system” when used herein refers to a system for wirelessly transferring electromagnetic energy from a vehicle to a garment worn by a rider of the vehicle, the system being a subject of the present invention.

Tank area—the area of a motorcycle which, if it had an internal combustion engine, would hold the fuel. In electric motorcycles, the tank area may be used for the battery, power electronics, control electronics and/or storage, for example.

### B. Exemplary Embodiments

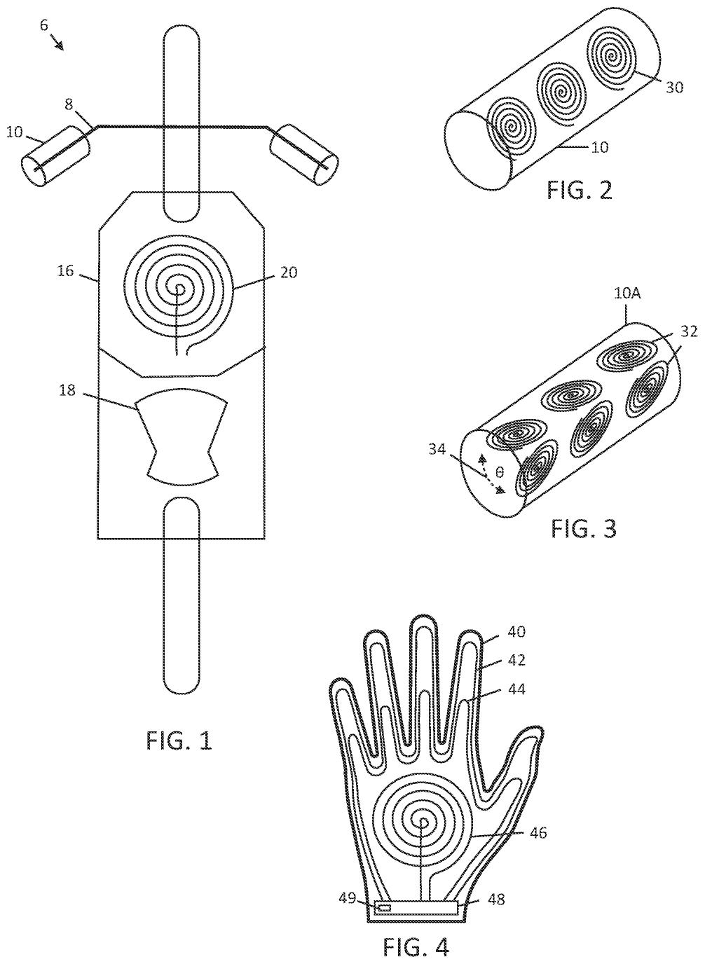

Referring to FIG. 1, there is shown a schematic drawing of a motorcycle 6. From the top view, it can be seen that each handlebar 8 has a handlebar grip 10, which is a conduit for inductive heating and charging when used in conjunction with its complementary receptor glove. The induction, which originates from the grip 10 is powered by the electric system of the motorcycle 6. A similar system can be configured to operate with various other electrically powered vehicles with handlebars, such as tricycles, quad bikes or snowmobiles. The handlebar grips 10 may have several different configurations of inductive coils, and may be referred to as induction zones.

In an induction zone such as the tank area 16, which was traditionally the tank of the gasoline motorcycle, there are one or more induction coils 20, in addition to the ones on the handlebars. The coil(s) 20 in the tank area 16 may be a single large coil wound in a diminishing spiral or of constant diameter, or multiple small ones of similar constant diameter, different constant diameter or in spirals. The tank area induction coil 20 wirelessly charges electronics stored in or on the tank area, such as a cell phone providing services such as GPS direction-finding, operational applications to control various systems on the motorcycle itself, or communication programs to allow wireless communication between riders through the helmet or headset, for example. The tank area induction coil(s) 20 also charge other accessories and in some embodiments provide some induction heating through specifically designed induction receptors on the rider's jacket, when the rider is hunched over the tank area 16, which is in front of the seat 18.

Inductive heating and charging usually requires close proximity between the powered inductive coils and the receptor coils. This is achieved by the handlebar grip 10, as the receiving glove will grasp the handlebar grip directly. The tank area coil 20 also provides on-contact accessory charging or close-proximity charging. A rider's inductive jacket provides inductive heating and charging via the part of the jacket which similarly comes into proximity with the tank area 16 when the rider is hunched over in an aerodynamic position. A rider's inductive jacket may also provide inductive heating and charging via a lengthened piece of the jacket comes into proximity with the tank area 16.

Referring to FIG. 2, there is shown a schematic drawing of an inductive handlebar grip 10. The handlebar grip 10 is a hollow rubber-type cylinder, which securely encompasses the handlebar 8 of the motorcycle 6. There are two such grips 10, one on each end of the handlebar 8. This grip 10 has conductive metal coils 30 which are connected to and carry current from the electric motorcycle power system. The current permits the coils 30 to inductively heat and/or charge complementary metallic components or coils in specially configured gloves. The inductive grips 10 may also be configured for use as accessories to other electrically powered vehicles, such as e-bikes, electric mobility devices or power-assisted pedal bikes.

The coils 30 in the grip 10 are shown in a single row configuration of wound diminishing spirals, angled to face toward the rider's palm (e.g. at 35° from horizontal). There are three inductive coils 30 in each grip 10, for example. In other embodiments, the windings of the coils may be of a constant diameter, different coils may have different diameters, and coils may have shapes other than circular. In some embodiments, the coils are not planar, and follow the approximate profile of the cylindrical surface of the grip 10.

Referring to FIG. 3, the coils 32 in the grip 10A are shown in a double row configuration in order to provide inductive coverage to both the palm and fingertips of the rider's hand. Each row of three coils 32 is, for example, in a plane at a 120° angle to the other, for example, depicted in the illustration by angle theta 34. Since the grips 10A are cylindrical in shape, they can adequately provide inductive coverage to the most of the inner surface of the rider's hand.

The inductive grips 10, 10A may either wirelessly heat the rider's hand when the gloved rider grasps the grip, or charge the glove to store energy for later use such as heating the rider's hand when not grasping the handlebar 8. In some embodiments they are configured to both heat the glove and charge a battery in the glove.

Referring to FIG. 4, there is shown a schematic drawing of an inductive glove 40. The glove 40 is the receptor component required to complete the induction process which originates from the grip 10. When the gloved hand holds onto the motorcycle grip 10, the conductive flexible coils 42, 44, 46 on the palm side of the glove come into close proximity with the powered coils 30, 32 in the grip and into range of the inductive magnetic field. Through direct induction heating, resistive heat is generated in the conductive coils 42, 44, 46 in the glove, and it is dissipated through the wire and the glove material. In this way, the warm glove 40 offers heat to the rider's hand when exposed to the cold airstream in cooler weather throughout the year.

The glove 40 may also be charged in the induction process, and the energy stored in a rechargeable lithium-ion battery so that it will be capable of heating the rider's hand even when not operating the motorcycle 6. Charging will also generate resistive heat, so the two inductive operations (heating, charging) may be concurrent, making the inefficiencies in charging of benefit to the heating process. In some cases, the heating and charging may be sequential.

In the glove 40, the first coil 42 is positioned to the edge of the glove extremities all the way up to the rider's fingertips. The second coil 44 is positioned apart from and inside the first coil 42, extending half way along the length of the fingers, until it reaches the finger joints. The third coil 46 is wound in a diminishing spiral or other configuration over the palm area. All the coils 42, 44, 46 begin and end at a control circuit 48 within, for example, an adjustable padded band at the wrist end of the glove 40. The glove 40 with its coils 42, 44, 46 may have a limited bend radius due to its inner components. However, the bend radius is tight enough so that the glove can grip around the handle bar without discomfort to the wearer. The glove's conductive component materials include flexible coils together with, for example, a flexible PCB. There may be an RFID tag 49 or other identification unit in the glove, and it may be located in or in proximity to the control circuit 48.

In the induction process to heat the gloves 40, the conductive coil 42, 44, 46 is resistive, i.e. not a very efficient conductor, in order to dissipate power generated by the fluctuating magnetic field into the heat sought after by the cold rider. When the target glove coil 42, 44, 46 is used for its properties as an electrical circuit to charge the gloves 40, more efficient conductive wire is preferred. The types of wires chosen may reflect an optimal balance of inductive heating vs. inductive charging, according to the optimal overall efficiency of the heating and charging combination as generally needed by the rider. The control circuit may switch the coils 42, 44, 46 so that they are open or closed, and may switch in coils of different resistance depending on the mode of operation of the glove. Control may be automatic, e.g. based on sensing the ambient temperature, or via input through a user interface of the control circuit 48, or wirelessly via a user's personal mobile telecommunication device.

The induced magnetic field is a type of electromagnetic radiation (EMR). When a person is in proximity of an induction ring, they become part of the electromagnetic circuit, since people have some electrical conductivity. However, energy tightly coupled between the transmitting and receiving coils exhibits sufficiently small leakage fields to the surroundings, allowing the coils to operate at relatively high power levels and transmit up to several watts with minimal impact to exposure potentials. In terms of occupational health and safety, the external unperturbed temporal peak field strengths should not exceed reference levels of 83 V/m for the electric field and 90 Nm for the magnetic field, for example. Hands positioned on the grip 10 on the handlebar 8 are located a relatively large distance from the head and vital organs of the torso, so in normal use the grips pose a low operational safety risk.

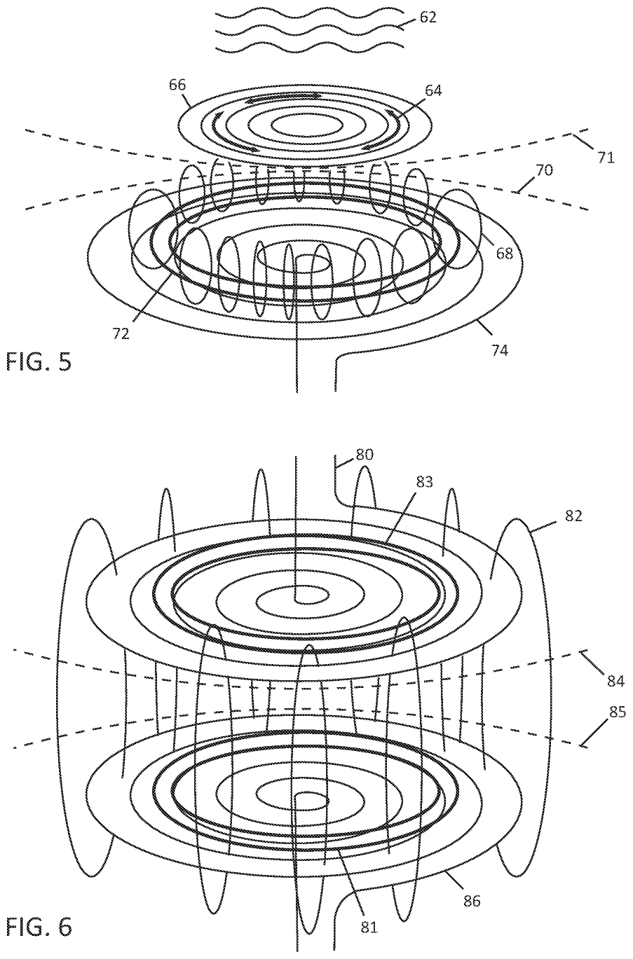

Referring to FIG. 5, there is shown a schematic drawing of an exploded view of the principle of inductive heating. In an embodiment of the invention the inductive coils in the glove/grip and jacket/tank area pairings may function to heat the rider in a similar manner to an induction stove, for example.

Induction occurs when a primary circuit 74 is in close proximity to a conductive material, which may be a plate conductor or a secondary circuit, such as upper coil 66. The upper coil 66, or target conductor, may exhibit magnetic hysteresis for further heating effect, in addition to resistive heating. The primary circuit 74 induces currents in the resistive conducting material, if it is a coil, which dissipates the energy in the form of heat 62. Alternately, the primary circuit 74 induces eddy currents in the resistive conducting material if it is a plate, which dissipates the energy in the form of heat 62. In reference to the motorcycle, a primary coil in the motorcycle grip 10 or tank area 16 generates an electric AC current symbolized by rings 72. The current back and forth around rings 72 produces a primary magnetic field 68 that fluctuates with the AC current. The lower insulator 70 on the motorcycle surface, such as the rubber grip 10 or fiberglass tank area 16, covers the inductive coil of the primary circuit 74 and protects the rider and other conductive materials from touch contact with the coil.

The upper insulator 71 represents the material of the glove 40 or jacket, which may be considered a target for the inductive energy transfer. The target glove or target jacket comes into close proximity with the primary current 72 when grasping the grip 10 or placing a portion of the jacket on the tank 16, and the primary magnetic field 68 induces currents 64 in the glove or jacket coil 66. The eddy currents 64 flow through the resistance of the coil 66 and dissipate their energy through heat 62, which warms the rider. Shown in the figure is the concentric spiral inductive coil of the primary circuit 74 as in the tank area 16 or grip 10. When electric current 72 is generated from the motorcycle battery power system, the resultant fluctuating magnetic field 68 induces currents 64 in the glove or jacket conductive coils 66 which provide heat 62 for the glove 40 or jacket and subsequently warm the rider.

Referring to FIG. 6, there is shown a schematic drawing of an exploded view of the principle of inductive charging. Induction occurs when two circuits 80, 86 are in close proximity, and AC current in the primary circuit 86 induces an electric current in the secondary circuit 80. The changing magnetic field 82 generated by the electric current in the primary circuit 86, symbolized by rings 81, will, for example, induce the upper electric current 83 in the secondary circuit 80. When a conductive metal coil such as the metal coil 42, 44, 46 in the glove 40 or jacket is brought into close proximity with the induction ring or primary circuit 86, it becomes part of the electromagnetic circuit. Insulators 84, 85 cover each electrical circuit 80, 86 respectively to shield it from touch contact with the rider or other conductive objects.

Shown is a schematic of the motorcycle inductive charging used to charge the glove 40, jacket, and various accessories such as a cell phone. The lower circuit 86 represents, for example in the motorcycle tank area 16 or grip 10, a coil 20, 30, 32 carrying electrical current generated by the motorcycle battery power system. The resulting fluctuating magnetic field 82 created by the AC current induces current in the target glove coil 42, 44, 46 or jacket coil, when positioned adjacent to the lower circuit 86 as in the diagram. The current generated in the glove or jacket circuit powers attached accessories or is stored in rechargeable batteries in the materials.

When inductively charging any device, the resistance of the coil also generates heat, which then transfers by thermal conduction into adjacent material of accessories or garments worn by the rider.

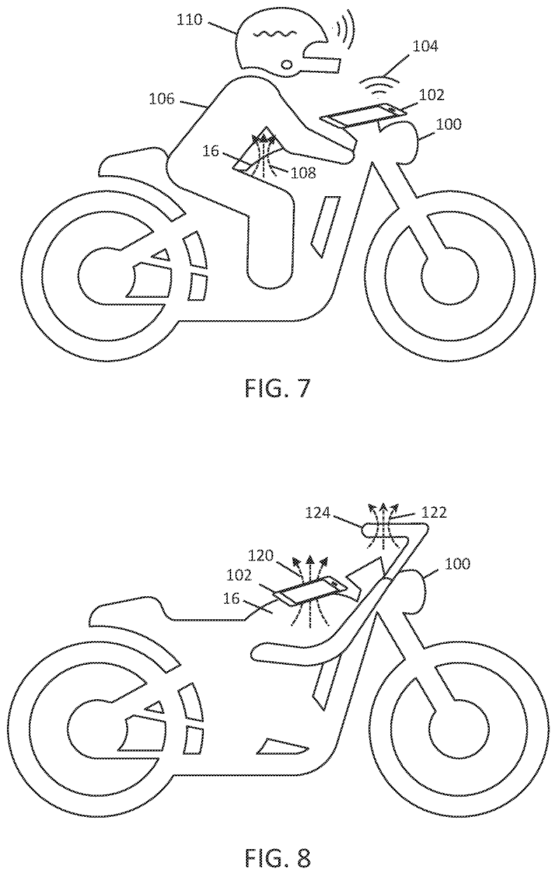

Referring to FIG. 7, there is shown a schematic drawing of inductive heating on a motorcycle. The motorcycle 100 has an inductive coil that indirectly heats the rider 106 via induction 108 from the tank area 16. The rider's cell phone 102 mounted on the front of the motorcycle is able to communicate via a wireless protocol 104 to the jacket, gloves, helmet 110 and inductive charger coils in the motorcycle. Via the communication, settings on the cell phone 102 are able to control the operation of one or more of the jacket, gloves, helmet 110 and inductive charger coils in the motorcycle.

For example, the cell phone may also communicate with the rider through the powered helmet 110. The helmet is powered via the inductive electrical system and it is charged when the jacket collar transmits current originating from the motorcycle 100 through the jacket, via a wired connection or inductive energy transfer between the helmet and the jacket. Alternately, or as well, the helmet may include a rechargeable battery. The smart helmet 110 is capable of a multitude of wireless operations, such as communication through the cell phone 102 to other riders using a similar helmet. The helmet uses an embedded camera as a smart navigation aid, and it has RFID device identification, enabling its digital signal key to communicate with individual electronic peripherals of the motorcycle, or functions of the motorcycle, such as ignition, for example.

Referring to FIG. 8, there is shown a schematic drawing of inductive charging. The motorcycle battery pack of the motorcycle 100 charges devices in close proximity to the tank area 16, in which there is an inductive charger that produces magnetic field 120. A device that may be charged could be a cell phone 102 clipped onto the tank area. The target cell phone coil converts the induced AC current into DC, via a rectifier on the induction compatible phone 102, so that the transferred energy may be stored within the cell phone battery. The illustration also depicts the inductive magnetic field 122 emanating from the handlebar grip 124 used to heat a glove.

Referring to FIG. 9, there is shown a schematic drawing of an inductive jacket 140. The jacket 140 has target inductive circuitry 141 extending down into the lower flap 142, which will come into close proximity of the inductive magnetic field emitted from the tank area 16 when the rider sits on the motorcycle. The interface between the inductive coil of the tank area and the target coil of the jacket flap 142 functions within about 40 mm, and may use loosely coupled resonance to increase inductive efficiency. This flap 142 sits on the tank area 16 with optimal touch contact, and has enough lateral leeway (e.g. 15 mm) to align the primary and target coils while allowing for shifting of the rider's position. The induction interface may be at the bottom portion of the flap 142, away from the rider's lower torso and reproductive organs. Induction fields interfere with credit cards and pacemakers, although induction fields drop off rapidly from their source. Thus the inductive charge interface, as a source of electromagnetic radiation, is placed a distance from the torso. The flap 142 may be extendable from the jacket so it comes into inductive contact with the tank area 16 when desired during riding. However, at other times it may be desirable to tuck in the flap 142 and secure it back inside the jacket 140. There are several ways this may be achieved, e.g. by folding it inwards and holding it in place with small, permanent magnets, or folding it into a pouch, or retracting it upwards between the inner and outer material layers of the jacket. In some embodiments, the flap 142 extends down below a lower front edge of the jacket and serves no purpose in itself as a garment even though it is connected to the garment.

The jacket 140 has numerous pockets 146 for rider accessories, including accessories also to be inductively charged via the tank area 16. The jacket 140 is wired up with circuitry, from the flap 142 and in other parts of the jacket, to accommodate charging the multiple objects stored in the jacket pocket compartments, as desired. The charging operation and location of working electronic devices are largely situated in the arm pockets, away from the torso, if they are inductively charged. Current-carrying wires and wireless devices also emit EMR, so it may be desired to distance AC and operational electronics from the heart, breast, and vital organs. Wireless devices intended for use near or against the body (such as cell phones, tablets and other portable devices) operating at or below 6 GHz, have an allowable FCC (Federal Communications Commission) SAR limit of 1.6 watts per kilogram (W/kg) of safe exposure to RF energy, as averaged over one gram of tissue.

The jacket circuitry extends up to the collar 144 so the collar may come into contact or close proximity with the rider's helmet. With power supplied inductively to the helmet from the jacket, the helmet may be heated and use wireless communication, and may provide other functions. An RFID tag 149 may also be included in the jacket.

When the current is delivered into the jacket 140, it is instead or also used to heat the rider. Heating devices are strategically placed in key warming locations in the jacket to coordinate with the rider's upper body. By using specific locations to heat the rider's torso and maintain the rider's overall comfort, the rider may be warmed while yet maintaining the induction fields a safe distance from the chest and vital organs.

The inductively charged jacket 140 may store power in a rechargeable lithium-ion battery for further use. Inductive current receptor targets for charging require a circuit to transmit the current onward to the battery or other device. The jacket charges the battery in a trickle charge and the jacket uses the battery power to operate several devices in the electrical circuitry at once, e.g. if they are plugged into the jacket. In this way, more power can be utilized than the limit of what the instantaneous inductive charging provides. The battery may be located on the jacket arm, for example, at a distant point from the torso, in keeping with the safe positioning of batteries for the electromagnetic radiation they emit during operation. Further limiting the EMR exposure, shielding material may be added strategically to specific jacket areas, as required.

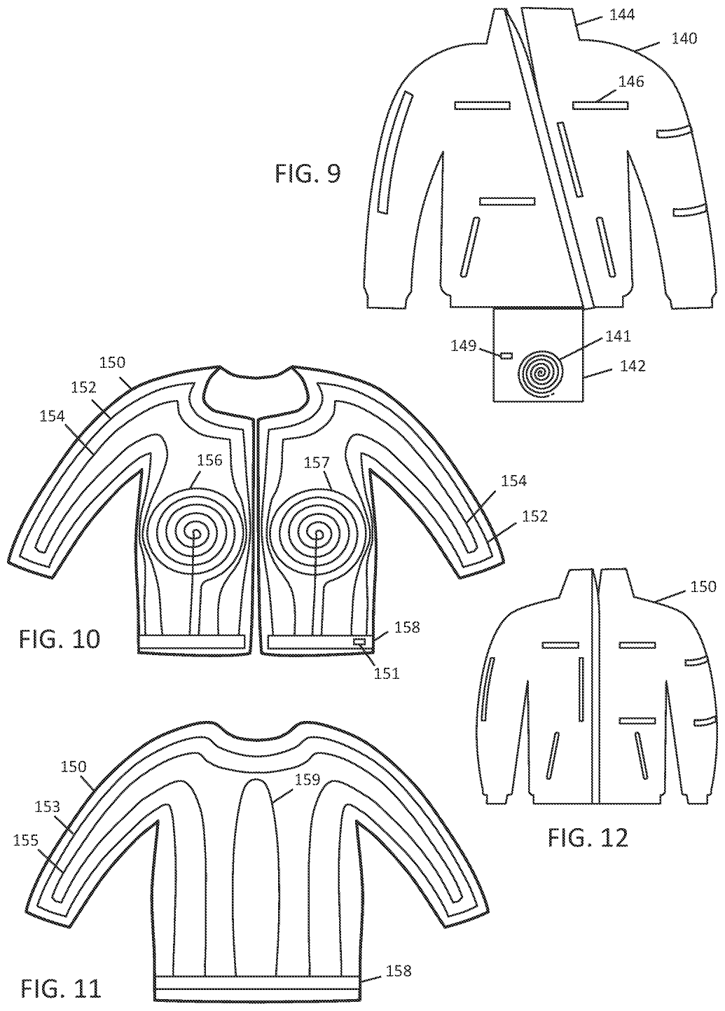

Referring to FIGS. 10-12, there are shown schematic drawings of the front circuit, back circuit and shell of another inductive jacket 150, respectively. The jacket shell depicts the outer style of the jacket, while the front and back views of the jacket 150 illustrate a general layout of its inductive components. The shell may be used as an outer protective cover for the inductive circuitry in the jacket 150 as well as for the rider. Induction fields may pass through insulator materials, such as the shell itself, paper maps, napkins, etc., stored in the outer pockets.

In this jacket 150, the inductive and/or heating coils 152, 154, 156, 157 cover the entire front of the jacket. Heating coils 153, 155, 159 cover the rear of the jacket. Different from the jacket 140 in FIG. 9, the coils 156, 157 in jacket 150 are spread and depicted directly over the torso area. Heating by induction occurs uniformly and directly over the torso and arms via these inductive coils 156, 157 and heating loops 152, 153, 154, 155, 159. The heat produced by the coils 152, 153, 154, 155, 156, 157, 159 heats the material of the jacket, and the warm jacket 150 heats the rider.

The inductive charging of accessories may also occur in any region of the jacket 150, provided that the accessory is in a pocket that aligns with the primary induction coil in the tank area. The pockets for these electronic accessories may be located behind the coils 156, 157 for example. The inductive charging of accessories may also occur in any region of the jacket 150, provided that there is a primary inductive coil there to transfer energy onwards from the jacket to the accessory. In one example, coil 156 may be used to receive energy from a coil in the tank area, and coil 157 may be used to transmit energy to a device located in a pocket aligned with coil 157.

To protect the rider from the adverse health effects of EMR, from the electrical circuitry transmitting current throughout the jacket to the accessories, from the operation of the accessories themselves, and from the induction heating and charging processes, there may be a protective material acting as an EMR shield which is placed between some or all of the coils and the rider. The coils heat the surrounding jacket material, but the EMR is prevented from permeating inward and compromising the physical safety of the rider's vital organs.

Electronics and metallic objects, which are conductors, may be placed in inner pockets and behind the EMR shielding material. These inner pockets, which are earmarked to house such electronic accessories and metallic devices, may be lined both front and back with the shielding material, to protect the rider from the EMR the accessories emit during their operation, as well as to protect the accessories themselves from the induced EMR from the motorcycle.

The outer shell protects the inductive and/or heating coils 152, 154, 156, 157 in the front and heating coils 153, 155, 159 in the back of the jacket 150. The coils divide into multiple segments for different areas of the body. All the coils begin and end at a control circuit 158 in, for example, an adjustable padded band at the waist end of the jacket 50. An RFID tag 151 may also be included in the jacket.

The first coil 152 is positioned to the edge of the jacket extremities all the way around the rider's torso and arms, in each of the segments. The second coil 154 is positioned somewhat parallel to and inside of the first coil 152, extending almost to the extremities of the arms and torso. The third coil 156 is wound in a diminishing spiral over the center of the breast area inside the first two coils 152, 154. The same applies to the fourth coil 157. The jacket 150 with its flexible coils 152, 153, 154, 155, 156, 157, 159 may have a limited bend radius to accommodate its component conductive materials together with PCB.

The jacket 150 is the receptor component required to complete the inductive energy transfer process, which originates from the tank area 16. When the rider wearing the jacket 150 leans over the motorcycle tank area 16 in a racing position, for example, the conductive flexible coils 156, 157 on the front of the jacket come into proximity with the powered coil 20 in the tank area and into range of its inductive magnetic field. Resistive heat is generated via electrical resistance, and optionally magnetic hysteresis, in the conductive coils in the jacket 150, and it is dissipated through the wire and the jacket material. In this way, the warm jacket 150 offers heat to the rider's upper body when exposed to the cold airstream in cooler weather throughout the year. However, when the rider is sitting erect, the jacket/tank area induction pair is not in close enough proximity to couple the transmitting and receiving coils and complete the induction process.

The jacket 150 may also be charged in the induction process, and the energy is used to charge electrical/electronic accessories or is stored in a rechargeable lithium-ion battery so that it will be capable of heating the rider's upper body or charging accessories even when the rider is not hunched over the tank area 16 or operating the motorcycle 6. Charging will also generate resistive heat, so the two inductive operations (charging, heating) may be concurrent, making the inefficiencies in charging of benefit to the heating process.

In the induction process to heat the jacket 150, one or more of the coils 152, 153, 154, 155, 156, 157, 159 may be electrically resistive, i.e.—not a very efficient conductor, in order to dissipate power generated by the fluctuating magnetic field into the heat sought after by the cold rider. When the target jacket coil 156, 157 is used for its properties as an electrical circuit to charge the jacket 150, more efficient conductive wire is preferred. The types of wires chosen may reflect an optimal balance of inductive heating vs. inductive charging, according to the optimal overall efficiency of the heating and charging combination as generally needed by the rider.

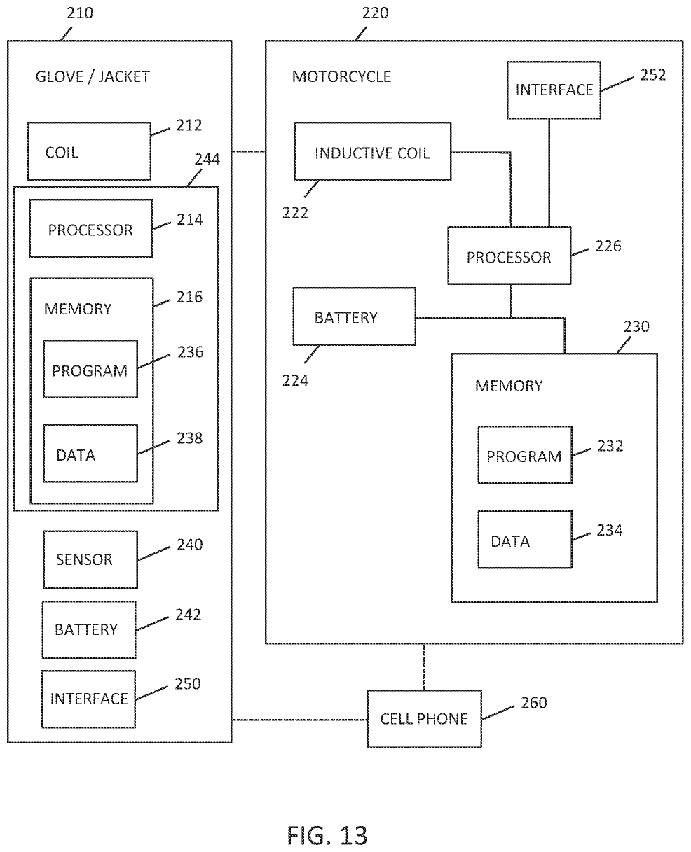

Referring to FIG. 13, there is shown a block diagram of the inductive heating system. The glove 210 (or jacket) has a target inductive coil 212, which may represent multiple coils of different types (inductive, heating or both) depending on the embodiment. The glove also has a processor 214, which regulates the inductive processes of heating and/or charging. The memory 216 stores an operating program 236 and data 238, which includes control settings, the status of the induction processes as the system monitors the circuit charge, charge storage, and glove temperature.

The program 236 includes computer readable instructions stored in computer-readable memory 216, which when executed by the processor 214, cause the system to carry out one or more of its functions. The program 236 may access and use the computer-readable data 238 also stored in the computer readable memory 216.

Temperature of the glove may be monitored by temperature sensor 240, for example. A rechargeable battery 242 may be included in the glove. The processor 214 and the memory 216 may form part of the control circuit 244 of the glove. A wireless interface 250 may also be present in the glove for wireless communication with a rider's cell phone 260, for example.

On the motorcycle 220 is a primary inductive coil 222, which may, depending on the embodiment, represent multiple different induction coils of different types. The motorcycle also has a processor 226 of its own to regulate the production of the originating inductive power from the battery 224. The motorcycle memory 230 also stores its operating program 232 and data 234 which records the status of the induction processes as the system monitors the circuit current, charge storage, control settings, and any feedback information indicating operational temperatures. The motorcycle may also have an interface 252 for wireless communication with the rider's cell phone 260, for example.

The program 232 includes computer readable instructions stored in computer-readable memory 230, which when executed by the processor 226, cause the system to carry out one or more of its functions. The program 232 may access and use the computer-readable data 234 also stored in the computer readable memory 230. The processor 226 and memory 230 may form a module within the motorcycle 220, or may be part of an electronic control unit (ECU) of the motorcycle.

### C. Variations

While this system has been described predominantly for use in motorcycles, any two-wheeled mode of transportation (i.e. scooters, e-bicycles) as well as 3-wheeled or 4-wheeled open-air vehicles may find use of it, particularly if the driver or rider is exposed to the weather. The system may also be used in watercraft, for example.

Handlebar grips with inductive coils may be installed in factory during manufacture of a motorcycle. In other embodiments, handlebar grips with inductive coils may be configured to attach as external accessories to existing motorcycles, or to electric pedal bikes or other electrically powered mobility devices, for example. The same applies to the inductive coil in the tank area of a motorcycle.

Inductive heating and charging may also be enabled on areas of the motorcycle seat and lateral to the saddle area, down the sides of the motorcycle, for heating and charging of the rider's seat, thighs and lower legs, through appropriate gear.

Resonant coupling may be enabled to amplify the inductive charge transfer and increase efficiency. The rechargeable batteries in the gloves and the jacket may in some embodiments be flexible. Coils may be repositioned, in the jacket for example, to accommodate safety precautions for EMR and other considerations. Depending on the position of the coils in the jacket and in the induction zone of the motorcycle, the inductive charging and/or heating may occur when the jacket is both opened and closed.

Inductive coils in the jacket and the gloves may be located in positions other than shown in the examples. They may be of different sizes, shapes, they may have a different number of windings, they may have different conductor resistivities, there may be a different number of them, or they may be located to match the position of a secondary inductive coil of an inductively chargeable device when in a jacket pocket. Coils may be wound and other circuit components may be selected for resonant coupling. Coils may be routed differently, for example they could be nested within each other or they may be side by side. Generally, the more a coil is wound, the stronger the inductive effect. Coils may be independently opened or closed by a switch in the control circuit.

A coil that has been described for use as a secondary coil for direct heating purposes, i.e. direct induction heating, may be replaced with a sheet of conductive material in which eddy currents are generated. This sheet of material may also exhibit magnetic hysteresis. Inductive heat receptor targets only require poorly conducting metallic material to be present, as eddy currents form throughout this material and rapidly dissipate into heat. Inductive heat receptor targets thus have a wide variety of possible coil configurations including a plate, metal fragments or any other suitable conductor.

In some embodiments, an RFID tag is not used, as the circuitry in the motorcycle is able to detect a change of the inductance in the primary inductance coils when a metallic object or receptor coil of a garment, such as an inductive jacket or inductive glove, is placed in its vicinity. Upon detecting the presence of the coil, for example, in the garment, the motorcycle automatically increases the power input to the primary coil.

Throughout the description, specific details have been set forth in order to provide a more thorough understanding of the invention. However, the invention may be practiced without these particulars. In other instances, well known elements have not been shown or described in detail and repetitions of features have been omitted to avoid unnecessarily obscuring the invention. In general, unless otherwise indicated, singular elements may be in the plural and vice versa with no loss of generality. Accordingly, the specification is to be regarded in an illustrative, rather than a restrictive, sense.

The detailed description has been presented partly in terms of methods or processes, symbolic representations of operations, functionalities and features of the invention. A software implemented method or process is here, and generally, understood to be a self-consistent sequence of steps leading to a desired result. It will be further appreciated that the line between hardware, firmware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as solid state memories, etc. The methods may alternatively be embodied partly or wholly in specialized computer hardware, such as integrated circuitry.

It will be clear to one having skill in the art that further variations to the specific details disclosed herein can be made, resulting in other embodiments that are within the scope of the invention disclosed. Modules may be divided into constituent modules or combined into larger modules. Features of one embodiment may be used with features of another embodiment to form further embodiments. Depending on the embodiment, all or fewer than all the advantages described herein may be achieved. All parameters, dimensions, angles, components and configurations described herein are examples only and actual ones of such depend on the specific embodiment. Accordingly, the scope of the invention is to be construed in accordance with the substance defined by the claims.

1. A motorcycle comprising:
an induction zone;
an electric circuit producing an alternating current; and
a primary induction coil through which the alternating current flows, the primary induction coil located in the induction zone;
wherein the primary induction coil is oriented to generate an alternating magnetic field outside an outer surface of the induction zone when the alternating current flows through the primary induction coil.

2. The motorcycle of claim 1, wherein the induction zone is in a tank area of the motorcycle.

3. The motorcycle of claim 1, wherein the induction zone is in a handlebar grip of the motorcycle.

4. The motorcycle of claim 1, further comprising an electronic circuit that detects a presence of a garment that has an electrical conductor for receiving energy from the alternating magnetic field.

5. The motorcycle of claim 1, further comprising an electronic circuit that detects a presence in the alternating magnetic field of an electrical conductor for receiving energy from the alternating magnetic field, the electrical conductor being part of a garment.

6. The motorcycle of claim 1, further comprising:
an interface for wireless communication with a personal mobile electronic communication device; and
a controller that controls the alternating current in response to a command received from the personal mobile electronic communication device.

7. A system for wirelessly transferring electromagnetic energy comprising:
a motorcycle, comprising:
an induction zone;
an electric circuit producing an alternating current; and
a primary induction coil through which the alternating current flows, the primary induction coil located in the induction zone;
wherein the primary induction coil is oriented to generate an alternating magnetic field outside an outer surface of the induction zone when the alternating current flows through the primary induction coil; and
a garment, comprising:
a heating element; and
an electrical conductor in the heating element or connected to transfer power to the heating element;
wherein the electrical conductor is located so that it is in the alternating magnetic field when a wearer of the garment rides the motorcycle;
wherein the alternating magnetic field induces further alternating current in the electrical conductor and the further alternating current is used to heat the heating element.

8. The system of claim 7, wherein the garment is a glove.

9. The system of claim 7, wherein the garment is a jacket.

10. The system of claim 9, wherein the garment comprises a flap that extends down below a front lower edge of the jacket and the electrical conductor is located in the flap.

11. The system of claim 7, wherein the garment further comprises:
a battery; and
a charging circuit that charges the battery using the further alternating current.

12. The system of claim 7, wherein the electrical conductor is a coil.

13. A method for wirelessly transferring electromagnetic energy comprising:
producing an alternating current with an electric circuit in a motorcycle;
flowing the alternating current through a primary induction coil that is located in an induction zone of the motorcycle;
generating an alternating magnetic field outside an outer surface of the induction zone when the alternating current flows through the primary induction coil;
inducing a further alternating current in an electrical conductor that is present in a garment that is worn by a rider of the motorcycle and located so that the electrical conductor is in the alternating magnetic field; and
using the further alternating current to heat the garment via a heating element that comprises the electrical conductor or is connected to receive power from the electrical conductor.

14. The method of claim 13, wherein:
the induction zone is in a tank area of the motorcycle and the garment is a jacket; or
the induction zone is in a handlebar grip of the motorcycle and the garment is a glove.

15. The method of claim 13, further comprising using the further alternating current to charge a battery in the garment.

16. The method of claim 13, further comprising using the further alternating current to charge an accessory in the garment.

17. The method of claim 13, further comprising using the further alternating current to transfer power to a helmet worn by the rider.

18. A garment for wirelessly receiving electromagnetic energy comprising:
a heating element; and
an electrical conductor in the heating element or connected to transfer power to the heating element;
wherein the electrical conductor is located so that, when a wearer of the garment rides a motorcycle, the electrical conductor is in an alternating magnetic field generated by the motorcycle;
wherein the alternating magnetic field induces alternating current in the electrical conductor and the alternating current is used to heat the heating element.

19. The garment of claim 18, further comprising:
a battery; and
a charging circuit that charges the battery using the alternating current.

20. The garment of claim 18, wherein the garment is a jacket that comprises a flap that extends down below a front lower edge of the jacket and the electrical conductor is located in the flap.

21. The garment of claim 18, wherein the garment is a jacket that comprises an electromagnetic radiation shield between the electrical conductor and an inner lining of the jacket.
